(19) United States
(12) Patent Application Publication
(10) Pub. No.: US 2014/0069414 A1
(43) Pub. Date: Mar. 13, 2014

(54) RANGE HOOD OF VAPOR-CLEANING TYPE

(71) Applicant: HSIAO-PING HUNG, TAICHUNG CITY (TW)

(72) Inventor: HSIAO-PING HUNG, TAICHUNG CITY (TW)

(21) Appl. No.: 13/608,037

(22) Filed: Sep. 10, 2012

(51) Int. Cl. F24C 15/20; B01D 45/18

(52) U.S. Cl. 126/299 D; 96/228

(57) ABSTRACT

A range hood of vapor-cleaning type has a chamber module and a vapor-cleaning module. The vapor-cleaning module has a tank, a pump, and a heater. The pump is connected with the tank and the heater. The tank is filled with water, and the water in the tank is pumped to the heater to be heated into vapor by the heater. The vapor is pumped in the chamber module to melt grease adhering in the chamber module. A temperature of the vapor is high, such that grease adhering in the chamber module is melted easily.

### BACKGROUND OF THE INVENTION

1. Field of the Invention

The present invention relates to a range hood, and more particularly to a range hood that is cleaned with vapor.

2. Description of Related Art

When a conventional range hood is used, the conventional range hood draws in fume through a rotating fan and exhausts the fume to the outdoors. However, when the conventional range hood is used for a long time, grease that is not exhausted to the outdoors adheres in the conventional range hood and the conventional range hood needs to be disassembled for interior cleaning, which causes inconvenience for use. Therefore, a range hood of electric thermal cleaning type and a range hood of water-cleaning type are provided to replace the conventional range hood.

With reference to FIG. 6, the range hood of electric thermal cleaning type comprises a chamber body 50, two fans, two oil pans and a heating module 60. The chamber body 50 is shell-shaped. The heating module 60 comprises multiple heaters 61 mounted on the chamber body 50. The heaters 61 are connected with a power cell electrically. When the conventional, range hood is to be cleaned, the heaters 61 heat the chamber body 50 to melt the grease adhering in the chamber body 50.

However, the heaters 61 cannot heat the fans and the oil pans, such that the grease adhering on the fans and the oil pans are not easy to be cleaned and a cleaning effect of the range hood of electric thermal type is not sufficient. In addition, heating the chamber body 50 causes a temperature in the range hood of electric thermal type to rise, such that the temperature may affect the performance of electric components in the range hood of electric thermal type.

With reference to FIG. 7, the range hood of water-cleaning type comprises a chamber body 70 and a nozzle 80. The chamber body 70 is shell-shaped. An end of the nozzle 80 is inserted into the chamber body 70, and the other end of the nozzle 80 is connected with a water source. When the range hood of water-cleaning type is in the cleaning mode, water is sprayed into the chamber body 70 through the nozzle 80 from the water source to wash away the grease adhering in the chamber body 70.

A washing liquid is added in the water to enhance the cleaning effect of the range hood of water-cleaning type. However, when the range hood of water-cleaning type is in the cleaning mode, the washing liquid will generate multiple bubbles. The bubbles may flow over the chamber body 70 and off from the chamber body 70. Furthermore, the washing liquid is not environmental friendly.

To overcome the shortcomings of the conventional range hoods, the present invention provides a range hood of vapor-cleaning type to mitigate or obviate the aforementioned problems.

### SUMMARY OF THE INVENTION

The main objective of the present invention is to provide an improved range hood of vapor-cleaning type, which comprises a housing, a chamber module, and a vapor-cleaning module.

The housing has a top board mounted on a top of the housing, and an outlet vent formed on the top board.

The chamber module is mounted in the housing and has a chamber body, at least one fan, at least one oil pan, and an oil sump. The chamber body has a body space formed in the chamber body, at least one inlet vent formed in a bottom of the chamber body and being opposite to the top board, and an outlet vent formed in a top of the chamber body and facing the outlet vent of the housing. The at least one fan is rotatably mounted in the chamber body. The at least one oil pan is respectively mounted on the at least one inlet vent. The oil sump is mounted in the chamber body and connected with the at least one oil pan.

The vapor-cleaning module is mounted in the housing and has a tank, a pump, a heater, a tank tube, a pump tube, and a heater tube. The tank, the pump, and the heater are mounted in the housing space. The tank tube is connected with the tank and the pump. The pump tube is connected with the pump and the heater. The heater tube is connected with the heater and the chamber module. The tank is filled with water, and the water is pumped to the heater to be heated into vapor. The vapor heated is pumped in the chamber module to melt grease adhering in the chamber module. Because a temperature of the vapor is high, the grease adhering in the chamber module is melted easily, and a cleaning effect of the range hood of vapor-cleaning type is better than that of the conventional range hood.

Other objects, advantages, and novel features of the invention will become more apparent from the following detailed description when taken in conjunction with the accompanying drawing.

### BRIEF DESCRIPTION OF THE DRAWINGS

FIG. 1 is an exploded perspective view of a first preferred embodiment of a range hood of vapor-cleaning type in accordance with the present invention;

FIG. 2 is a perspective view of the range hood of vapor-cleaning type in FIG. 1;

FIG. 3 is an operational bottom view of the range hood of vapor-cleaning type in FIG. 1 with a bottom cover removed;

FIG. 4 is an operational side view in partial section of the range hood of vapor-cleaning type in FIG. 1.

FIG. 5 is an operational bottom view of a second preferred embodiment of a range hood of vapor-cleaning type in accordance with the present invention;

FIG. 6 is a perspective view of a chamber body of a conventional range hood of electric thermal cleaning type; and

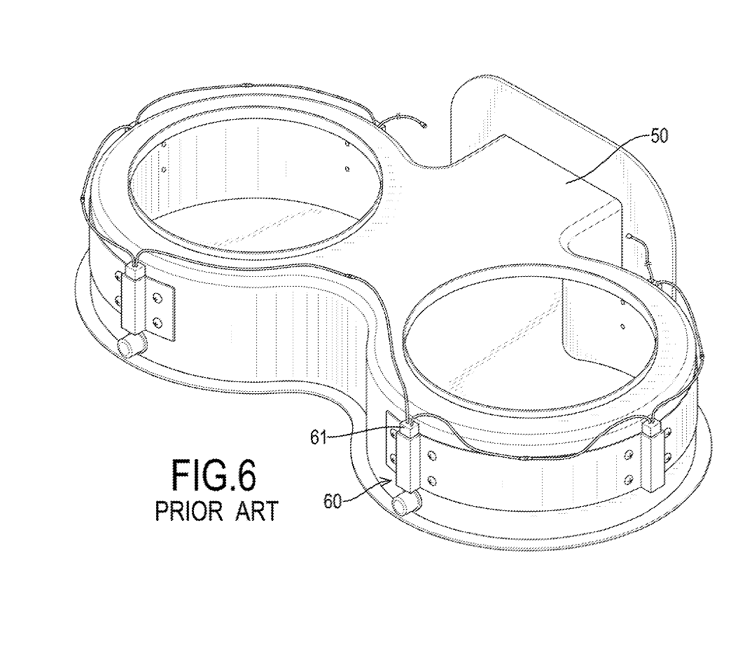

FIG. 7 is a perspective view of a chamber body of a conventional range hood of water cleaning type.

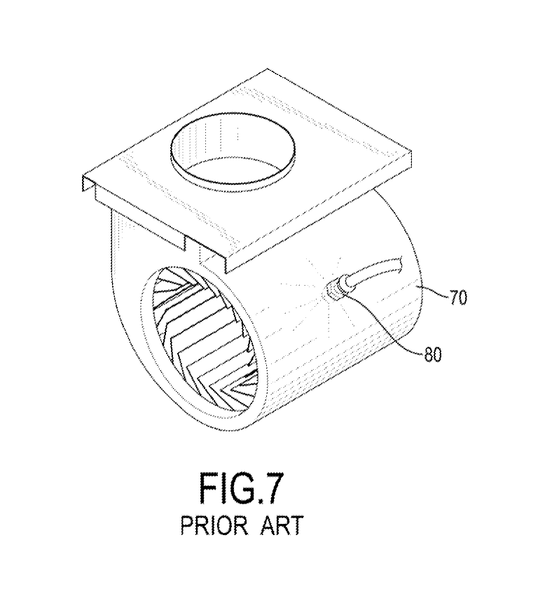

### DETAILED DESCRIPTION OF PREFERRED EMBODIMENT

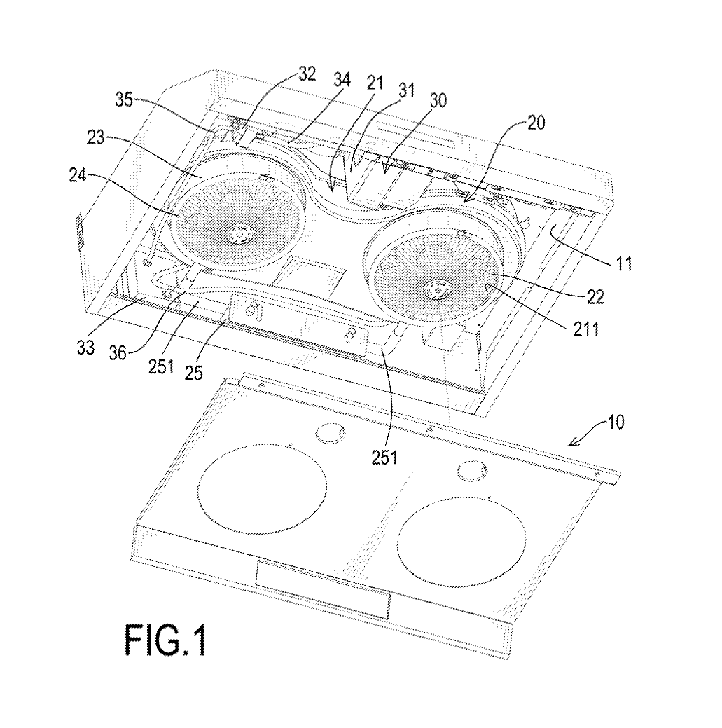

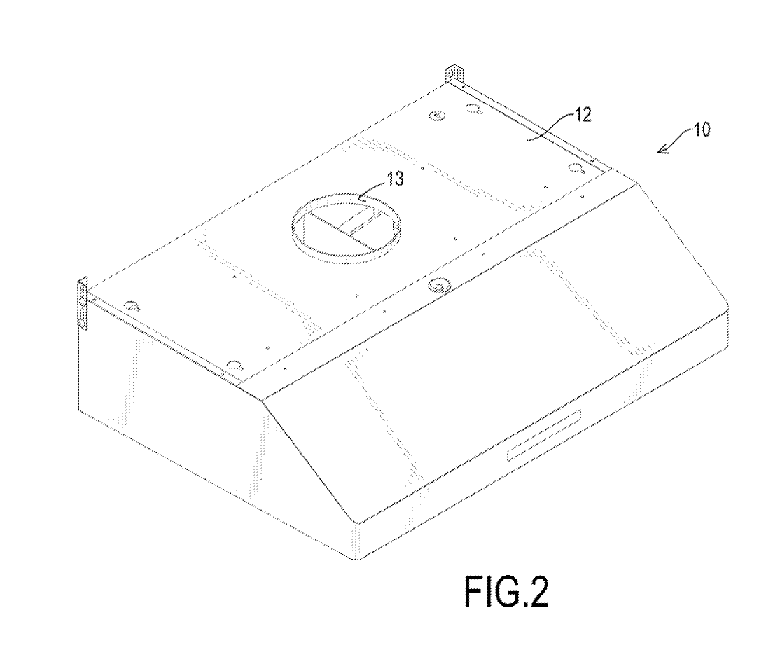

With reference to FIG. 1 to FIG. 3, a first preferred embodiment of a range hood of vapor-cleaning type in accordance with the present invention comprises a housing 10, a chamber module 20, and a vapor-cleaning module 30.

The housing 10 comprises a housing space 11, a top board 12, and an outlet vent 13. The housing space 11 is formed in the housing 10. The top board 12 is mounted on a top of the housing 10. The outlet vent 13 is formed through the top board 12 and is located at a middle of the top board 12.

The chamber module 20 is mounted in the housing space 11 and comprises a chamber body 21, two fans 22, two oil pans 23, two oil nets 24, and an oil sump 25. The chamber body 21 is gourd-shaped, and the chamber body 21 has a body space, two inlet vents 211 and an outlet vent 212. The body space is formed in the chamber body 21. The inlet vents 211 are formed in a bottom of the chamber body 21 opposite to the top board 12. The outlet vent 212 of the chamber body 21 is formed in a top of the chamber body 21 and faces the outlet vent 13 of the housing 10.

The fans 22 are rotatably mounted in the chamber body 21 and face the inlet vents 211 respectively. The oil pans 23 are mounted on the inlet vents 211 respectively. The oil nets 24 are mounted on the oil pans 23 respectively. The oil sump 25 is mounted at a side of the chamber body 21 and has two oil tubes 251. The oil tubes 251 are connected with the oil sump 25 and connected to the oil pans 23 respectively.

The vapor-cleaning module 30 is mounted in the housing space 11 and comprises a tank 31, a pump 32, a heater 33, a tank tube 34, a pump tube 35, and a heater tube 36. The tank 31, the pump 32 and the heater 33 are mounted in the housing space 11. The tank tube 34 is connected with the tank 31 and the pump 32. The pump tube 35 is connected with the pump 32 and the heater 33. The heater tube 36 has three ends. One end of the heater tube 36 is connected with the heater 33, and the other ends of the heater tube 36 are connected with the chamber body 21 at positions corresponding to the fans 22 respectively.

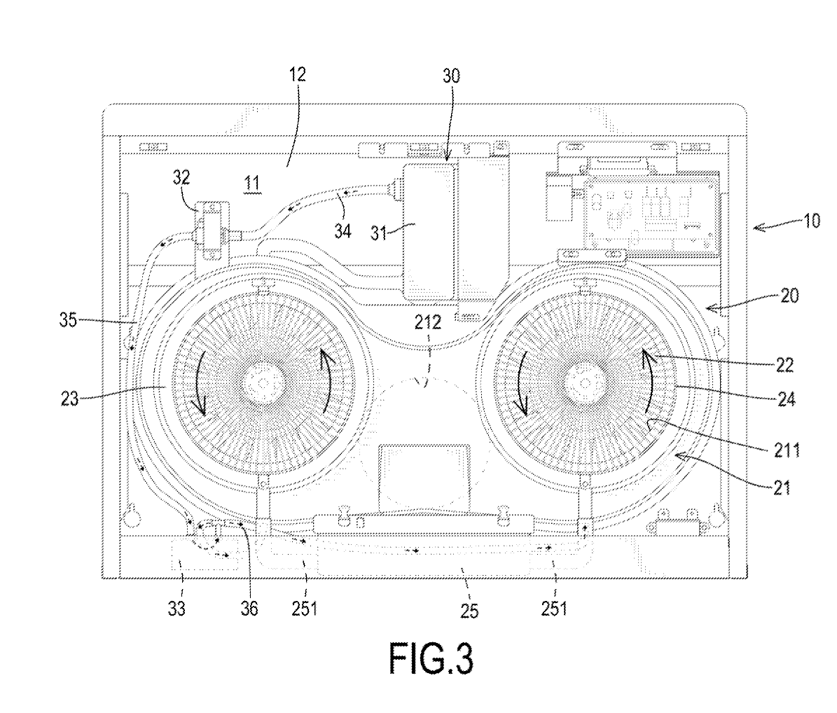

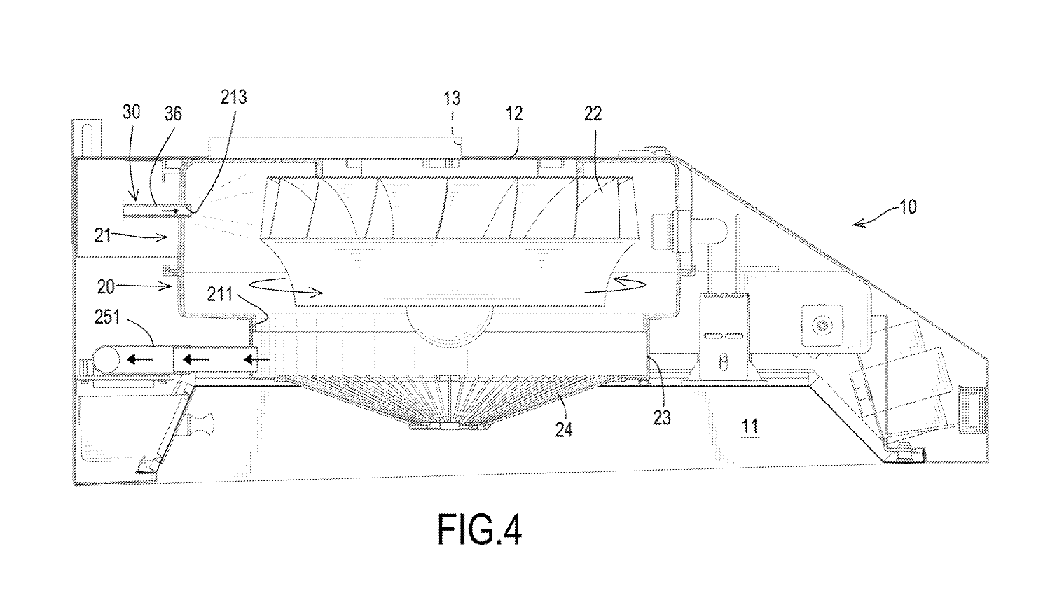

With reference to FIG. 3 and FIG. 4, when the range hood is in use, the fans 22 are rotated to draw fume into the chamber body 21 through the inlet vents 211 of the chamber body 21 and to exhaust fume from the outlet vent 212 of the chamber body 21. A portion of grease in the chamber body 21 will flow into the oil pans 23 and be further led to the oil sump 25 through the oil tubes 251, and other grease will adhere in the chamber body 21.

In the cleaning mode, the tank 31 is filled with water, and the water in the tank 31 is pumped to the heater 33 by the pump 32 through the tank tube 34 and the pump tube 35. The heater 33 heats the water into vapor, and then the vapor is pumped into the chamber body 21 through the heater tube 36. As a result, the grease adhering in the chamber body 21 will be melted due to the high temperature of the vapor, and then the vapor and some of the melted grease are discharged out from the chamber body 21 by the fans 22 through the outlet vent 212 of the chamber body 21, and some of the melted grease will flow into the oil sump 25. Accordingly, the chamber body 21 can be cleaned. In addition, the heater 33 can heat water to a high temperature but not yet into vapor, and the hot water is pumped into the chamber body 21 to do further cleaning.

Furthermore, because only the water in the tank 31 is heated, the temperature in the housing 10 is not increased, which avoids impairing the performance of electric components mounted in the chamber body 10. The range hood in accordance with the present invention uses high temperature vapor to melt grease adhering in the chamber body 21, such that washing liquid is unnecessary for the range hood in accordance with the present invention. Therefore, the present invention is environmental friendly.

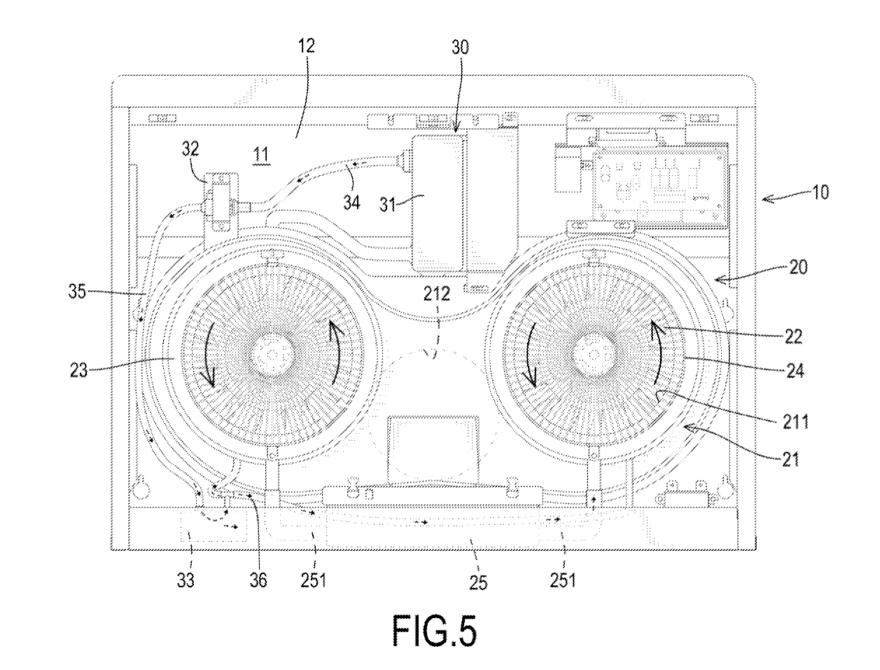

With reference to FIG. 5, a second preferred embodiment of the range hood in accordance with the present invention is substantially the same with the first embodiment, but the heater tube 36 is connected with the heater 33 and the oil pans 23.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A range hood comprising:
a housing having
a top board mounted on a top of the housing; and
an outlet vent formed on the top board;
a chamber module mounted in the housing and having
a chamber body having
a body space formed in the chamber body;
at least one inlet vent formed in a bottom of the chamber body and being opposite to the top board: and
an outlet vent formed in a top of the chamber body and facing the outlet: vent of the housing;
at least one fan rotatably mounted in the chamber body;
at least one oil pan mounted respectively on the at least one inlet vent; and
an oil sump mounted in the chamber body and connected with the at least one oil pan; and
a vapor-cleaning module mounted in the housing and having
a tank mounted in the housing space;
a pump mounted in the housing space;
a heater mounted in the housing space;
a tank tube connected with the tank and the pump;
a pump tube connected with the pump and the heater; and
a heater tube connected with the heater and the chamber module.

2. The range hood as claimed in claim 1, wherein the heater tube is connected with the oil pan and the heater.

3. The range hood as claimed in claim 1, wherein
the chamber body has two inlet vents in the chamber body;
the chamber module has
two oil pans mounted on the inlet vents respectively; and
two fans rotatably mounted in the chamber body and facing the inlet vents respectively; and
the heater tube has three ends and the ends of the heater tube are connected with the heater and the oil pans respectively.

4. The range hood as claimed in claim 2, wherein
the chamber body has two inlet vents in the chamber body;
the chamber module has
two oil pans mounted on the inlet vents respectively; and
two fans rotatably mounted in the chamber body and facing the inlet vents respectively; and
the heater tube has three ends and the ends of the heater tube are connected with the heater and the oil pans respectively.

5. The range hood as claimed in claim 1, wherein the heater tube connected with the chamber body and the heater.

6. The range hood as claimed in claim 1, wherein
the chamber body has two inlet vents in the chamber body; and
the chamber module has
two oil pans mounted on the inlet vents respectively; and
two fans rotatably mounted in the chamber body and facing the inlet vents respectively;
the heater tube has three ends and the ends of the heater tube are connected with the heater and with the chamber body at positions corresponding to the fans respectively.

7. The range hood as claimed in claim 5, wherein
the chamber body has two inlet vents in the chamber body;
the chamber module has
two oil pans mounted on the inlet vents respectively;
two fans rotatably mounted in the chamber body and facing the inlet vents respectively;
the heater tube has three ends and the ends of the heater tube are connected with the heater and with the chamber body at positions corresponding to the fans respectively.
